(19) United States
(12) Patent Application Publication
(10) Pub. No.: US 2008/0188260 A1
(43) Pub. Date: Aug. 7, 2008

(54) METHOD AND APPARATUS FOR UPLINK POWER CONTROL IN A COMMUNICATION SYSTEM

(75) Inventors: Wemin Xiao, Hoffman Estates, IL (US); Amitava Ghosh, Buffalo Grove, IL (US); Robert T. Love, Barrington, IL (US); Ravikiran Nory, Grayslake, IL (US); Rapeepat Ratasuk, Hoffman Estates, IL (US); Yakun Sun, Sunnyvale, CA (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/021,769

(22) Filed: Jan. 29, 2008

Related U.S. Application Data
(60) Provisional application No. 60/887,824, filed on Feb. 2, 2007.

(51) Int. Cl. H04Q 7/20

(52) U.S. Cl. 455/522

(57) ABSTRACT

A communication system optimizes cell edge performance and spectral efficiency by a first step of measuring, by the Node B, at least one system performance metric. A next step includes sending, by the Node B, an indicator for the at least one system performance metric measurement. A next step includes receiving the indicator for the at least one system performance metric measurement. A next step includes determining an adaptive power control parameter based on the at least one system performance metric measured by the Node B and system performance metrics measured by at the least one other neighboring Node B. A next step includes using the adaptive power control parameter to update an uplink transmit power level for at least one user equipment served by the Node B.

### CROSS REFERENCE TO RELATED APPLICATION

This application is related to U.S. patent application Ser. No. 11/621,125, attorney docket number CE15524R, filed Jan. 9, 2007, and entitled “Method and Apparatus for Uplink Resource Allocation in a Frequency Division Multiple Access Communication System,” and claims priority from U.S. patent application No. 60/815,171, attorney docket number CE16132R, filed Jun. 20, 2006, and entitled “Method and Apparatus for Uplink Power Control in a Frequency Division Multiple Access Communication System.”

### FIELD OF THE INVENTION

The present invention relates generally to Single Carrier and Multi-Carrier Frequency Division Multiple Access (FDMA) and Orthogonal Frequency Division Multiple Access (OFDMA) communication systems, and, in particular, to uplink power control in Single Carrier and Multi-Carrier FDMA and OFDMA communication systems.

### BACKGROUND OF THE INVENTION

Single Carrier and Multi-Carrier Frequency Division Multiple Access (FDMA) communication systems, such as IFDMA, DFT-SOFDMA, and OFDMA communication systems, have been proposed for use in 3GPP (Third Generation Partnership Project) and 3GPP2 Evolution communication systems for transmission of data over an air interface. In Single Carrier and Multi-Carrier FDMA communication systems, a frequency bandwidth is split into multiple contiguous frequency sub-bands, or sub-carriers, that are transmitted simultaneously. A user may then be assigned one or more of the frequency sub-bands for an exchange of user information, thereby permitting multiple users to transmit simultaneously on the different sub-carriers. These sub-carriers are orthogonal to each other, and thus intra-cell interference is reduced.

To maximize the spectral efficiency, a frequency reuse factor of one has been proposed for both a downlink and an uplink in Single Carrier and Multi-Carrier FDMA communication systems. With a frequency reuse factor of one, data and control channels in one sector/cell will likely experience interference from other sectors/cells. This is especially true for user equipment (UE) at the edge of a cell or at bad coverage locations. Therefore, letting each user equipment (UE) in a sector or cell transmit at full power on the uplink results in very poor edge performance. On the other hand, implementation of a traditional power control scheme, wherein each UE in a sector or cell transmits at an uplink power that results in a same received power at a radio access network for each such UE, suffers from a low overall spectral efficiency due to a lack of UEs that can transmit at high data rates.

Therefore, a need exists for a resource allocation scheme that results in a better tradeoff between the cell-edge performance and the overall spectral efficiency.

### BRIEF DESCRIPTION OF THE DRAWINGS

FIG. 1 is a block diagram of a wireless communication system in accordance with an embodiment of the present invention.

FIG. 2 is a block diagram of a Node B of FIG. 1 in accordance with an embodiment of the present invention.

FIG. 3 is a block diagram of a user equipment of FIG. 1 in accordance with an embodiment of the present invention.

FIG. 4 is a block diagram of an edge gateway of FIG. 1 in accordance with an embodiment of the present invention.

FIG. 5 is a logic flow diagram illustrating a method of uplink power control executed by the communication system of FIG. 1 in accordance with an embodiment of the present invention.

One of ordinary skill in the art will appreciate that elements in the figures are illustrated for simplicity and clarity and have not necessarily been drawn to scale. For example, the dimensions of some of the elements in the figures may be exaggerated relative to other elements to help improve understanding of various embodiments of the present invention. Also, common and well-understood elements that are useful or necessary in a commercially feasible embodiment are often not depicted in order to facilitate a less obstructed view of these various embodiments of the present invention.

### DETAILED DESCRIPTION OF THE INVENTION

To address the need for a resource allocation scheme that results in a better tradeoff between the cell-edge performance and the overall spectral efficiency, a communication system allocates uplink transmit power to a user equipment (UE) based on an adaptive power control parameter that is, in turn, based on system performance metric measurements of a serving Node B and neighboring Node Bs. The adaptive power control parameter is then used to determine an uplink transmit power of a user equipment (UE) served by the serving Node B.

In operation, the Node Bs can send a quantized indicator of the system performance metric measurements to one another or an edge gateway. These indicators are processed, by either or both of the edge gateway and Node Bs to adapt the power control parameters for the UEs. The uplink transmit power may be determined by the Node B and then conveyed to the UE, or the Node B may broadcast the adaptive power control parameter to the UE and the UE may self-determine the uplink transmit power.

In a general embodiment, the present invention encompasses a method for uplink power control by a Node B in a communication system. The method includes a first step of measuring, by the Node B, at least one system performance metric. A next step includes sending, by the Node B, an indicator for the at least one system performance metric measurement. A next step includes receiving the indicator for the at least one system performance metric measurement. A next step includes determining an adaptive power control parameter based on the at least one system performance metric measured by the Node B and system performance metrics measured by at the least one other neighboring Node B. A next step includes using the adaptive power control parameter to update an uplink transmit power level for at least one user equipment served by the Node B.

In one embodiment of the present invention, an edge gateway receives the indicators from a Node B and forwards these indicators to neighboring Node Bs. These neighboring Node Bs can adapt the power control parameters based on the received indicators and using their own system performance metric measurements.

In another embodiment of the present invention, the edge gateway receives the indicators from a Node Bs and pre-processes the received indicators, as will be described below, and sends the results to the Node Bs. The Node Bs then adapt the power control parameters based on these pre-processed results from the edge gateway and using their own system performance metric measurements.

In still another embodiment of the present invention, the edge gateway receives the indicators from Node Bs, adapts the power control parameters, and sends the adapted parameters to the Node Bs.

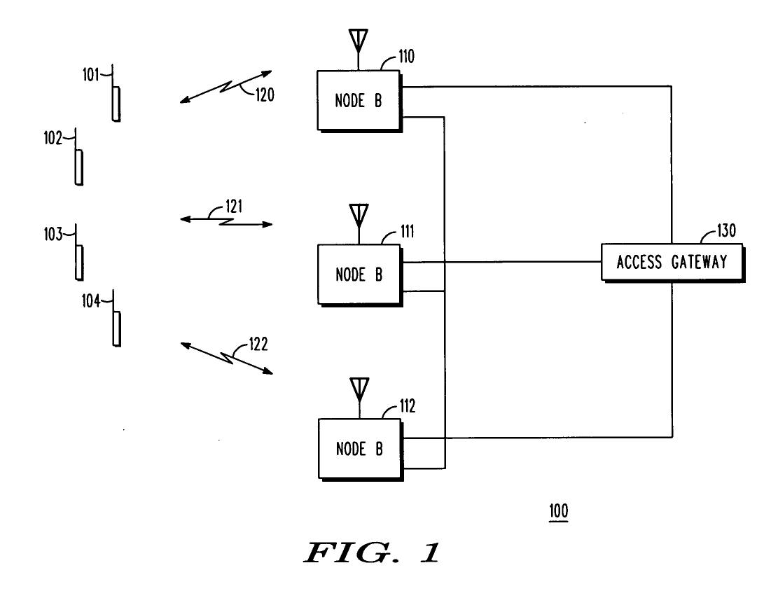

Referring to FIG. 1, a block diagram is shown of a wireless communication system 100 in accordance with an embodiment of the present invention. Communication system 100 includes multiple Node Bs 110-112 (three shown) that each provides wireless communication services to UEs residing in a coverage area, such as a cell or a sector, of the Node B via a respective air interface 120-122. Each air interface 120-122 comprises a respective downlink and a respective uplink. Each of the downlinks and uplinks comprises multiple physical communication channels, including at least one signaling channel and at least one traffic channel.

Each Node B of the multiple Node Bs 110-112 is in communication with the other Node Bs of the multiple Node Bs via one or more of a network access gateway 130 and an inter-Node B interface of backhaul that may comprise one or more of a wireline link and a wireless link of all of the Node Bs and via which each Node B may broadcast to the other Node Bs. As is known in the art, access gateway 130 is a gateway via which a network may access each of the Node Bs, such as a Radio Network Controller (RNC), a mobile switching center (MSC), a Packet Data Service Node (PDSN), or a media gateway, and via which the Node Bs may communicate with each other.

The communication system 100 further includes multiple wireless users equipment (UEs) 101-104 (four shown), such as but not limited to a cellular telephone, a radio telephone, a personal digital assistant (PDA) with radio frequency (RF) capabilities, or a wireless modem that provides RF access to digital terminal equipment (DTE) such as a laptop computer. For purposes of illustrating the principles of the present invention, it is assumed that each UE 101-104 is served by Node B 111.

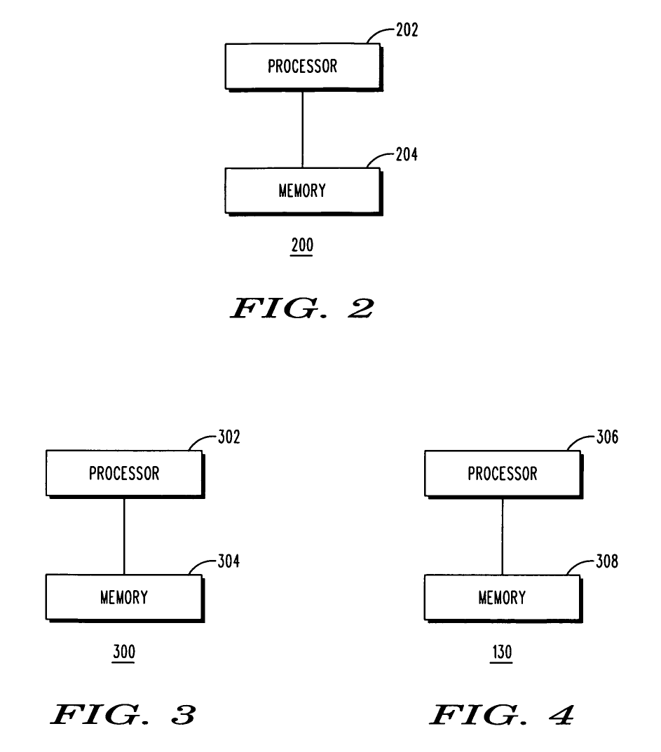

FIG. 2 is a block diagram of a Node B 200, such as Node Bs 110-112, in accordance with an embodiment of the present invention. Node B 200 includes a processor 202, such as one or more microprocessors, microcontrollers, digital signal processors (DSPs), combinations thereof or such other devices known to those having ordinary skill in the art. The particular operations/functions of processor 202, and thus of Node B 200, are determined by an execution of software instructions and routines that are stored in a respective at least one memory device 204 associated with the processor, such as random access memory (RAM), dynamic random access memory (DRAM), and/or read only memory (ROM) or equivalents thereof, that store data and programs that may be executed by the corresponding processor. Processor 202 further implements a scheduler, such as a Proportional Fair Scheduler, based on instructions maintained in the at least one memory device 204 and that determines and allocates a transmit power for each UE serviced by the Node B.

FIG. 3 is a block diagram of a user equipment (UE) 300, such as UEs 101-104, in accordance with an embodiment of the present invention. UE 300 includes a processor 302, such as one or more microprocessors, microcontrollers, digital signal processors (DSPs), combinations thereof or such other devices known to those having ordinary skill in the art. The particular operations/functions of processor 302, and respectively thus of UE 300, is determined by an execution of software instructions and routines that are stored in a respective at least one memory device 304 associated with the processor, such as random access memory (RAM), dynamic random access memory (DRAM), and/or read only memory (ROM) or equivalents thereof, that store data and programs that may be executed by the corresponding processor.

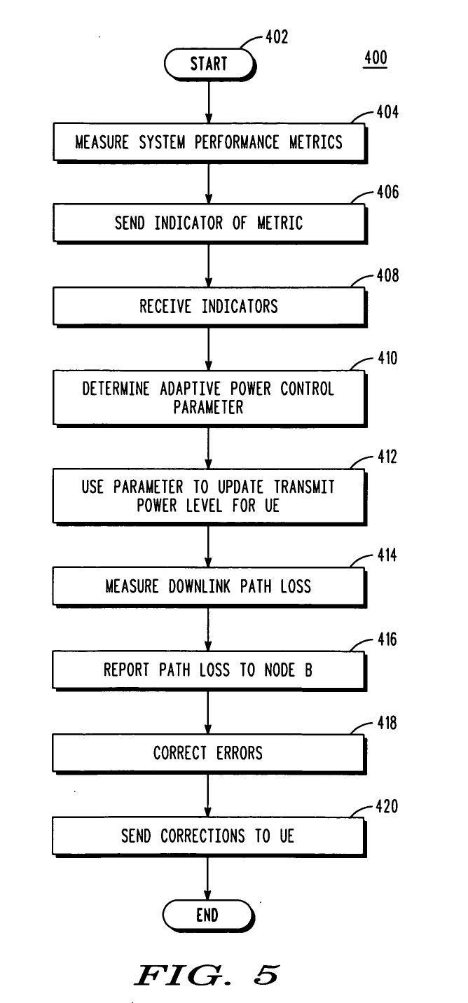

FIG. 4 is a block diagram of an edge gateway (eGW), such as access gateway 130, in accordance with an embodiment of the present invention. The gateway 130 includes a processor 306, such as one or more microprocessors, microcontrollers, digital signal processors (DSPs), combinations thereof or such other devices known to those having ordinary skill in the art. The particular operations/functions of processor 306, and respectively thus of the gateway 130, is determined by an execution of software instructions and routines that are stored in a respective at least one memory device 308 associated with the processor, such as random access memory (RAM), dynamic random access memory (DRAM), and/or read only memory (ROM) or equivalents thereof, that store data and programs that may be executed by the corresponding processor.

The embodiments of the present invention preferably are implemented within one or more of the access gateway 130, Node Bs 110-112 and UEs 101-104. More particularly, the functionality described herein as being performed by each of the access gateway 130 and Node Bs 110-112 is implemented with or in software programs and instructions stored in the memory and executed by an associated processor of the respective device. However, one of ordinary skill in the art realizes that the embodiments of the present invention alternatively may be implemented in hardware, for example, integrated circuits (ICs), application specific integrated circuits (ASICs), and the like, such as ASICs implemented in one or more of UEs 101-104, Node Bs 110-112, and access gateway 130. Based on the present disclosure, one skilled in the art will be readily capable of producing and implementing such software and/or hardware without undo experimentation.

Communication system 100 comprises a wideband packet data communication system that employs a Single Carrier or a Multi-Carrier Frequency Division Multiple Access (FDMA) or Orthogonal Frequency Division Multiple Access (OFDMA) air interface technology, wherein a frequency bandwidth is split into multiple frequency sub-bands, or subcarriers, that comprise the physical layer channels over which traffic and signaling channels are transmitted simultaneously. A user may then be assigned one or more of the frequency sub-bands for an exchange of user information, thereby permitting multiple users to transmit simultaneously on the different sub-carriers. Further, communication system 100 preferably operates in accordance with the 3GPP (Third Generation Partnership Project) E-UTRA (Evolutionary UMTS Terrestrial Radio Access) standards, which standards specify wireless telecommunications system operating protocols, including radio system parameters and call processing procedures. However, those who are of ordinary skill in the art realize that communication system 100 may operate in accordance with any wireless telecommunication system employing a frequency division multiplexing scheme or a time and frequency division multiplexing scheme, wherein a sub-band comprises a frequency sub-band or a time and frequency sub-band, such as a 3GPP2 (Third Generation Partnership Project 2) Evolution communication system, for example, a CDMA (Code Division Multiple Access) 2000 1XEV-DV communication system, a Wireless Local Area Network (WLAN) communication system as described by the IEEE (Institute of Electrical and Electronics Engineers) 802.xx standards, for example, the 802.11a/HiperLAN2, 802.11g, 802.16, or 802.21 standards, or any of multiple proposed ultrawideband (UWB) communication systems.

In order to optimize system performance at the edges of a coverage area, communication system 100 can provide uplink fractional power control and minimum bandwidth allocation. That is, at any given time and for a given coverage area associated with a Node B of the multiple Node Bs 110-112, such as Node B 111, communication system 100 allocates an uplink transmit power to each UE, such as UEs 101-104, served by the Node B and which power is designed to provide acceptable received power at the Node B while minimizing interference among all such UEs and UEs in adjacent coverage areas. In addition, for any given Transmission Time Interval (TTI), the Node B, that is, Node B 111, determines and allocates a minimum amount of bandwidth to each UE 101-104 engaged in a communication session that is sufficient to provide acceptable service to the UE based on measured system performance metrics.

Referring now to FIG. 5, a logic flow diagram 400 is provided that illustrates a method of uplink power control executed by communication system 100 in accordance with an embodiment of the present invention. Logic flow diagram 400 begins (402) when each Node B of the multiple Node Bs 110-112 measures (404) one or more system performance metrics associated with a corresponding air interface 120-122. For example, the Node B may measure one or more of, an interference over thermal-noise ratio (IoT), a load in the coverage area such as a sector or a cell serviced by the Node B, a fairness or a cell-edge performance metric such as a fairness criterion or a cell edge user throughput, and a throughput associated with the Node B such as a cell or a sector throughput associated with the Node B. For example, the load in a coverage area may comprise one or more UEs in a coverage area, a number of active UEs in a coverage area, a number of channels that are available for assignment, or that are currently assigned, in a coverage area, a level of currently available, or currently utilized, transmit power at a Node B, or a total amount of transmit power currently assigned to UEs served by a Node B via a coverage area.

Fairness and cell-edge performance metrics are well-known in the art and will not be described in detail herein, except to note that fairness is typically implemented by a scheduler, such as a Proportional Fair Scheduler, residing in a Node B, such as Node Bs 110-112, and relates to an opportunity to transmit that is given to UEs served by the Node B and experiencing bad channel conditions. Similarly, cell-edge performance relates to an opportunity to transmit that is given to UEs residing at the edge of a cell and the quality of their signal as received at the serving Node B. However, one of ordinary skill in the art realizes that there are many ways for a Node B to determine system performance metrics associated with a UE serviced by the Node B, and any such method may be used herein without departing from the scope of the present invention.

As is known in the art, UEs served by a Node B report channel condition measurements to the Node B. In addition, each Node B can independently measure channel conditions, such as after Intra-site Interference (ISI) cancellation, for example. Therefore, in a next step 406 of the present invention, the system performance metrics measured by each of Node Bs 110-112 are sent as quantized indicators representing the measured metrics. For example, a Node B 110-112 can measure an uplink interference level or any other kind of uplink performance, such as a number of user equipment in serving cell, a fairness criterion, a cell edge user throughput, and a sector throughput, as are known in the art, associated with each sub-band of a bandwidth employed by communication system 100. One of ordinary skill in the art realizes that many parameters may be measured in determining channel quality and that any such parameter may be used herein without departing from the scope of the present invention. As is known in the art, a Node B can measure channel conditions for every sub-band during a measuring period, such as a Transmission Time Interval (TTI) (also known as a sub-frame) or a radio frame transmission period. Each Node B can further store the uplink channel condition measurements.

Each Node B of the multiple Node Bs 110-112 then defines a quantized indicator for each measurement report. For example, the Node B can define one or more bits where a “1” indicates an unacceptable performance for that metric and a “0” indicates acceptable performance. In particular, one metric can be uplink interference level, wherein a bit can be reserved or added that can indicate a “1” for unacceptable uplink interference and “0” for acceptable uplink interference. Another metric can be uplink performance, wherein a bit can be reserved or added that can indicate a “1” for unacceptable uplink performance and “0” for acceptable uplink performance. The Node B then sends 406 these indicators in an L2/L3 message on the network backhaul. In one example, the serving Node B can broadcast its indicators of system performance metric measurements directly to the other Node Bs of the multiple Node Bs via the network backhaul, preferably via an inter-Node B interface or via access gateway 130. In another example, the message is meant for the access gateway for full or partial processing before being sent on to the neighboring Node Bs.

Based on the system performance metric measurements received 408 from the other Node Bs of the multiple Node Bs 110-112, and further based on the system performance metric measured by the Node B with respect to its own air interface, each Node B 110-112 and/or gateway 130 then determines 410 an adaptive power control parameter that is used 412 to update an uplink transmit power level for each of the one or more UEs served by the Node B, such as each of UEs 101-104 with respect to Node B 111.

The above steps 406, 408, 410 can be performed in either or both of the Node Bs and gateway. In a first embodiment, the sending step 406 includes sending the indicator for the at least one system performance metric measurement from the Node B via a backhaul through an edge gateway, and the receiving step 408 includes receiving the indicator forwarded by the edge gateway by the at least one other neighboring Node B, wherein the determining step 410 is performed by the at least one other neighboring Node B. In this embodiment, the adaptive power control parameter is solely determined by the Node Bs (i.e. dumb eGW).

In a second embodiment, the measuring step 404 includes measuring at least one system performance metric by a plurality of Node Bs, the sending step 406 includes sending an indicator for the at least one system performance metric measurement by the plurality of Node Bs, the receiving step 408 includes receiving the indicators by the edge gateway, wherein the edge gateway adapts the power control parameters for the Node Bs and forwards the updates to the Node Bs, such that the determining step 410 is performed by the edge gateway. In this embodiment, the adaptive power control parameter is solely determined by the edge gateway (i.e. intelligent eGW).

In a third embodiment, the measuring step 404 includes measuring at least one system performance metric by a plurality of Node Bs, the sending step 406 includes sending an indicator for the at least one system performance metric measurement by the plurality of Node Bs, the receiving step 408 includes receiving the indicators by the edge gateway, wherein the edge gateway pre-processes the indicators for the Node Bs and forwards the pre-processed information to the Node Bs, such that the determining step 410 is performed by both the edge gateway and the plurality of Node Bs. In this embodiment, the adaptive power control parameter is determined between the gateway and Node Bs (i.e. less intelligent eGW).

In particular, in the third embodiment, the edge gateway pre-processes the messages from the neighboring Node Bs of the serving Node B and generates an indicator by comparing the number of Node Bs sending a particular indicator value against a threshold, wherein if the number of Node Bs sending a particular indicator value is greater than the threshold, the edge gateway sends the particular indicator value to the Node Bs.

More specifically, the edge gateway pre-processes the messages from the neighboring Node Bs of the serving Node B and generates two-bit message as follows: a) out of N neighboring Node Bs, if at least a predetermined number of them greater than a first threshold report an unacceptable interference level, then the first bit is set to “1”. Otherwise, the first bit is set to “0”. And b) out of N neighboring Node Bs, if at least a predetermined number of them report greater than a second threshold report an unacceptable uplink performance, then the second bit is set to “1”. Otherwise, the second bit is set to “0”. The first and second thresholds may be the same or different.

In any of the above embodiments, the next step comprises a using step 412 that includes a Node B sending updated power control parameters to user equipment it serves. In its simplest form, this step can include the Node Bs sending the updated power control parameters to the UEs. However, a physical sending may not be needed to use the parameter since the Node B would know the expected received power and could select Modulation Coding Scheme (MCS) levels to the uplink data/control channel transmission, where the UE can then set its transmit power according to the MCS level assigned.

Additionally, each UE can measure 414 the downlink path loss using downlink pilots, and can further update its transmit power according to a fractional power control scheme and the updated power control parameters. Similar to the above, this may not be needed to use the parameter since the Node B would know the expected received power and could select MCS levels to the uplink data/control channel transmission, where the UE can then set its transmit power according to the MCS level assigned. In this case the Node B may need to broadcast its Interference over Thermal (IoT) averaging over the system bandwidth. A bitmap may be sent to convey the differential between sub-bands when an interference avoidance scheme is used.

Further, the UE can then report 416 the updates of its path loss (and/or the transmit power level and/or the expected received power level) to the Node B for scheduling and resource allocation. A full report can be made for initial access or after a handover. To simplify, differential bits can be used after the initial access or handover.

At this point, the Node B can correct 418 errors using the reported downlink path loss, and send 420 the corrected power control commands to the user equipment. In particular, the correcting step 418 can include at least one of the group of, providing accumulated correction to the user equipment for measurement and power errors, and providing non-accumulated compensation to the user equipment for channel dependent scheduling.

Two types of error correction are envisioned; a) an accumulated correction needed for measurement error and power amplifier error (inasmuch as UEs typically use low-cost power amplifiers and the more accurate Node B can correct this error) being a quasi-static error, and b) non-accumulated compensation needed for channel dependent scheduling where the Node B has more information of the channel (due to uplink sounding or the Channel Quality Information (CQI) feedback channel) than the UE, which only knows the long term Carrier-to-Interference (C/I) ratio, or c) both.

To define which error correction is being provided, the Node B can take two approaches. In a first approach the Node B uses one-bit to differentiate the accumulated correction and the non-accumulated compensation. Alternatively, two-bits can be used to designate both error modes. In a second approach, a timing differential (TDM) can be used. For example, non-accumulated compensation can be sent with an uplink scheduling grant (in the downlink L1/L2 control channel) while accumulated corrections can be sent periodically or be event based.

In practice, the determination of the adaptive power control parameter is a function of the system performance metric measurements reported by the other Node Bs and system performance metric measured by the Node B and associated with the Node B's own air interface. For example, when the system performance metrics comprise IoT, cell load, a fairness/cell-edge performance metric, and a sector throughput, then the adaptive power control parameter may be determined based on the following equation, which equation is maintained in the at least one memory device 204 of the Node B and/or the at least one memory device 304 of each of UEs 101-104, and/or the at least one memory device 308 of the gateway 130,
Adaptive Power Control Parameter=f(I_{Node B 110}, LOAD_{Node B 110}, Fairness/CEP_{Node B 110}, ST_{Node B 110}, I_{Node B 111}, LOAD_{Node B 111}, Fairness/CEP_{Node B 111}, ST_{Node B 111}, I_{Node B 112}, LOAD_{Node B 112}, Fairness/CEP_{Node B 112}, ST_{Node B 112}, . . . )
   where ‘I_{Node B 110}’ represents the interference measured at Node B 110, ‘LOAD_{Node B 110}’ represents the load measured at Node B 110, ‘Fairness/CEP_{Node B 110}’ represents a fairness or cell-edge performance metric determined by Node B 110, ‘ST_{Node B 110}’ represents the sector throughput measured by Node B 110, ‘I_{Node B 111}’ represents the interference measured at Node B 111, and so on. In various embodiments of the present invention, the adaptive power control parameter may be a function of any one or more of these parameters determined at each Node B, so long as the same one or more parameters for each Node B are used to determine the adaptive power control parameter.

For example, the adaptive power control parameter may be represented by the symbol a and may be determined based on the following equation, which equation is maintained in the at least one memory device 204, 304, 308 of the Node B, UE, or gateway,

α(n)=α(n−1)−sgn{IₜΣc_{cell}I_{cell}}·Δ.

where ‘Δ’ represents a power adjustment step size, preferably in dB and comprising a small step, such as 0.1 dB or 0.01 dB. Iₜ represents a target system performance metric level, such as a target interference level and preferably an average system performance metric level, for the coverage area served by Node B 111. I_{cell} represents the system performance metric, for example, interference level, measured by and reported by each Node B 110-112. c_{cell} represents a weighting factor that is applied to the system performance metric measurements, for example, the interference level, reported by each Node B. c_{cell} is used to weight the system performance metric measurements of a Node B based on an anticipated impact of a channel condition, such as interference, generated in the cell served by the Node B on channel conditions in the coverage area of Node B 111. For example, c_{cell} may correspond to a distance of a Node B from serving Node B 111. Σ corresponds to a summing of c_{cell} I_{cell} over all of the multiple Node Bs 110-112, and α(n−1) represents a determination of a from a preceding uplink power level update period. When α is first determined, α(n−1) may be a predetermined value. ‘Sgn’ corresponds to a sign function, that is, when the quantity { } is less than zero (<0), then sgn{ }·Δ=−Δ, and when the quantity { } is greater than zero (>0), then sgn{ }·Δ=+Δ.

Further, based on downlink path loss measurements reported by UEs served by Node B 111, that is, UEs 101-104, the Node B determines a fractional path loss for each such UE. That is, Node B 111 determines a path loss (L) for each of UEs 101-104 and ranks the UEs based on their determined path losses. Typically, path loss L is determined as a ratio of transmit power to received power. For example, Node B 111 may determine a path loss for a UE by averaging path losses associated with each of the sub-bands measured and reported by the UE. However, other algorithms will occur to one of ordinary skill in the art for determining a path loss to be used in ranking a UE, such as using a best path loss or a worst path loss reported by the UE, which algorithms may be used herein without departing from the spirit and scope of the present invention. Based on the rankings, Node B 111 then determines a path loss of a UE that is ranked at a predetermined percentile in the rankings to produce a path loss threshold, that is, a path loss of a UE whose path loss is at the x^{th}-percentile level (Lₓ₋ᵢₗₑ). Node B 111 then compares the actual path loss of the UE (L) to the path loss threshold to determine a fractional path loss for the UE, for example, Lₓ₋ᵢₗₑ/L.

Node B 111 then determines an uplink transmit power level for each UE 101-104 based on the fractional path loss determined with respect to the UE and the adaptive power control parameter that is determined based on system performance metric measurements associated with each of Node Bs 110-112. Node B 111 updates, for each UE 101-104, the uplink transmit power level determined for the UE, Pₜ, based on the UE's maximum transmit power level for transmissions on uplink 114, Pₘₐₓ, a fractional power control parameter, F_{PC}, associated with the UE, and the adaptive power control parameter, represented in the following equation by α. The fractional power control parameter, F_{PC}, corresponds to a fraction, or portion, of the UE's maximum transmit power level that the UE is assigned for transmissions on uplink 114 and is based on the fractional path loss associated with the UE. More particularly, the uplink transmit power level, Pₜ, is determined for each UE 101-104, or each UE 101-104 self-determines an uplink transmit power level Pₜ, based on the following equation, which equation is maintained in the at least one memory device 204 of the Node B and/or the at least one memory device 304 of each of UEs 101-104, and/or the at least one memory device 308 of the gateway 130,

Pₜ=Pₘₐₓ×F_{PC}, where F_{PC}=min{1, max[Rₘᵢₙ,(Lₓ₋ᵢₗₑ/L)^{α}]}

Rₘᵢₙ is a minimum power reduction ratio, that is, a ratio of a minimum uplink transmit power level of a UE in communication system 100 to Pₘₐₓ. A value corresponding to Rₘᵢₙ is up to a designer of communication system 100 and is designed to prevent UEs experiencing good path loss, that is, a minimal path loss, from being required to transmit at too low a power level. For example, if it is desired that the minimum uplink transmit power of a UE not be less than one-tenth ( 1/10) of Pₘₐₓ, then Rₘᵢₙ=0.1. Again, the ratio Lₓ₋ᵢₗₑ/L corresponds to a fractional path loss experienced by a UE, that is, the ratio Lₓ₋ᵢₗₑ/L is a comparison of the actual path loss experienced by the UE (L) to a path loss threshold, preferably the path loss of a UE at the x^{th} percentile (Lₓ₋ᵢₗₑ) of all UEs serviced by Node B 111, or an ‘x-percentile path loss.’ ‘L’ is determined based on a downlink channel quality measured by the UE and/or an uplink channel quality measured by Node B 111. Preferably, L includes path loss resulting from shadowing and slow fading but does not include path loss resulting from fast fading. Lₓ₋ᵢₗₑ is a path loss of a UE at the x^{th} percentile of all UEs serviced by Node B 111. For example, if ‘x-ile’=5, that is, the 5^{th} percentile (5%-ile), then when all UEs serviced by Node B 111 are ranked based on path loss, Lₓ₋ᵢₗₑ is a path loss of a UE at the 5^{th} percentile (from the bottom) of all of the ranked UEs. A result is that all UEs whose path loss L is greater than Lₓ₋ᵢₗₑ (the bottom 5% when ‘x-ile’=5) may transmit at Pₘₐₓ, while UEs whose path loss L is less than Lₓ₋ᵢₗₑ may each transmit at a power level that is based on the comparison of their path loss L to the path loss threshold, that is, Lₓ₋ᵢₗₑ.

Node B 111 may use ‘α’ to determine Pₜ and may broadcast the adaptive power control parameter, that is, ‘α’, to the UEs 101-104 serviced by the Node B. Node B 111 further may determine a path loss threshold, that is, a path loss of a UE whose path loss is at the x^{th}-percentage level (Lₓ₋ᵢₗₑ), and inform each UE 101-104 serviced by the Node B of the path loss threshold by broadcasting the path loss threshold to the UEs. In response to receiving Lₓ₋ᵢₗₑ and a each UE 101-104 may store the parameters in the at least one memory device 304 of the UE and then self-determine the fractional path loss and an uplink transmit power, Pₜ, based on downlink channel conditions measured by the UE and the stored path loss threshold Lₓ₋ᵢₗₑ and α. Each UE 101-104 can then transmit data to Node B 111 at the uplink transmit power level determined for the UE.

Typically, 1>α>0. When α=0, then all UEs serviced by Node B 111 may transmit at full power (Pₜ=Pₘₐₓ) and UEs in the coverage area of Node B 111 are likely to experience high interference levels from the other UEs in the coverage area and poor edge performance, for example, due to the high uplink transmit power levels of UEs closer to Node B 111. When α=1, then all UEs serviced by Node B 111 may transmit at an uplink power level that results in the same received power at Node B 111, resulting in poor spectral efficiency. By adaptively adjusting α, communication system 100 is able to balance spectral efficiency with cell-edge performance, thereby providing an optimized combination of the two.

That is, by providing for a determination of an adaptive power control parameter based on system performance metric measurements associated with a serving Node B and further associated with, and reported to the serving Node B by, neighboring Node B's, which adaptive power control parameter is used to determine an uplink transmit power of a UE served by the serving Node B, communication system 100 provides edge users in a Single Carrier or a Multi-Carrier FDMA or OFDMA communication system, such as 3GPP or a 3GPP2 Evolution communication systems such as an E-UTRA communication system, with improved performance and a better chance to transmit while enhancing overall spectral efficiency. However, as a frequency reuse factor of one has been proposed for such communication systems, interference levels may be even further improved by providing for intra-site interference cancellation in the sectors serviced by a Node B.

Thus by providing for intra-site interference (ISI) cancellation, a communication system is able to mitigate the impact on one sector of a power allocation scheme employed in another sector. In addition, in order to optimize frequency re-use and to provide an optimal balance of cell-edge performance and spectral efficiency, a communication system determines an adaptive power control parameter based on system performance metrics determined by a serving Node B and further determined by, and reported to the serving Node B by, neighboring Node B's. The adaptive power control parameter is then used to determine an uplink transmit power of a UE served by the serving Node B.

In a preferred embodiment, Uplink (UL) power control in E-UTRA adjusts the UE total transmit power in order to achieve:
1. Successful packet reception after a targeted number of transmissions to achieve a desired QoS.
2. Reliable control channel transport.
3. Acceptable out of band emissions for coexistence or adjacent channel EVM near far problem.
4. Acceptable interference rise over thermal levels (IoT) in case: i) Maintain cell-edge coverage with acceptable cell edge performance and achieve high spectral efficiency simultaneously; ii) Data traffic with different QoS from different cells occupy the same uplink resources; iii) Data traffic and control transmissions from different cells share the same uplink resources.

UE transmit power control can be pathloss based. This means a UE can estimate the received power of the downlink (DL) common reference signal (RS) and with knowledge of the eNodeB RS transmit power level can then estimate pathloss (including shadowing and antenna gains) referred to here as L. With such an estimate the transmit power per resource block to achieve a given SINR target for a desired MCS is computed as:

P_{L}=SINR_{TARGET}×N_{TH/RB}(1+IoT)/L (1.0)

Here P_{L} should be less than P_{PC} which is the upper limit of the transmit power set by power control. The scheduler should take this upper limit into account when assign MCS to the UE. The UE periodically sends pathloss reports so that the serving eNodeB can determine the UEs expected transmit power level when it next schedules that UE. Downlink CQI reports can additionally be used by an eNodeB to better estimate a UE's expected transmit power level.

One practical power control scheme to determine the pathloss based power level (P_{PC}) is a fractional power control scheme where only a fraction of the pathloss is compensated when determining the UE's allowable transmit power level per resource block (power spectral density) as computed by

$${P}_{PC} = {P}_{MAX} \times min \{ \frac{1}{{N}_{RB}} , max [ {R}_{min} , {( \frac{{L}_{x - ile}}{L} )}^{α} ] \} \qquad ( 2.0 )$$

where
P_{MAX} is the maximum transmit power (nominal for power class),
N_{RB} is the number of resource blocks assigned to the UE,
Rₘᵢₙ is the minimum power reduction ratio to prevent UEs with good channels to transmit at very low power level,
Lₓ₋ᵢₗₑ is the x-percentile path loss (plus shadowing) value. If x set to 5, then statistically 5 percent of UEs with bad channels will transmit at P_{MAX}.
1>α>0 is the balancing factor for UEs with bad channel and UEs with good channel.

Since FDM resource allocation is used and each UE would only occupy a portion of the system bandwidth, the uplink power control should control the transmit power per resource block.

Different cellular system configurations require different optimal settings of the power control parameters. For example, in a system with large ISD, an optimal power control may require a majority of UEs to be able to transmit at full power due to power limited situation, while in a small ISD system, the power control may tend to limit the transmit power of most of the UEs to control the interference to an optimal level. Therefore, power control parameters need to be adapted based on different cellular system configurations, even for different sectors/cells in the same system.

An example of uplink power control adaptation scheme is described below:
1) Node-B measures system performance, such as the received interference level, (maybe after interference cancellation,) the active load of the sector, the fairness/cell-edge performance, and the sector throughput, etc.
2) Node-B sends the quantized measurement(s) to the neighboring Node-Bs through backbone networks (on a slow basis).
   For example, the Node-B sends 2 quantized measurements to the neighboring Node-Bs. Each could be just one bit. One bit indicates the interference level—acceptable or not. Another bit indicates the uplink performance—satisfied or not.
3) Node-B adapts its parameters of the power control scheme according to the measured information from neighboring Node-Bs and also on its own measurements.
   In the case of fractional power control, Lₓ₋ᵢₗₑ, and are the 2 key parameters. Although optimal Lₓ₋ᵢₗₑ, may vary from system to system, it is not likely to be adapted dynamically. Therefore, the Node-B will just adapt □ according to the uplink IoT and performance measurements of its own and from the neighboring Node-Bs.
4) Node-B sends power control commends (or scheduling grant messages) according to the updated power control parameter to the UEs or broadcasts updates of the power control parameters to the UEs if the power control is implemented in UEs.
5) Repeat step 1-4.

Due to estimation errors in determining T_{G} and IoT and the accuracy error in a UE device for setting a desired transmit power level (e.g. +−9 dB as in UMTS) there is a need for a correction to be applied to MCS selection and/or to the determined pathloss based power level (i.e. P_{L}) based on differences in expected and received uplink RS strength or SINR measurements as well as link errors in the form of:

i) UL packet transmission decoding errors (CRC failures, SER, etc)

ii) UL RS symbol errors.

Another reason for power correction is that when uplink sounding is available, the Node-B has more information about the channel than the UEs, especially for the case of frequency selective scheduling. The slow power control sets the average transmit power over the whole bandwidth for the UE, while the UE is usually granted to transmit using part of the bandwidth. Due to frequency selectivity, any part of the bandwidth experiences path loss and fading different from the whole bandwidth. Therefore, the Node-B schedules the UE to transmit at certain data rate based on its knowledge of the channel from path loss estimation and uplink sounding signal. On the other hand, the UE sets its transmit power based only on the path loss estimation.

For example, a UE estimates its path loss as −130 dB. The Node-B knows the path loss plus fading within the granted narrowband is −127 dB and, using transmission power of 2 dBm, the UE can support 16 QAM with code rate 0.5. When the UE receives the grant, based on the −130 dB path loss, it will set the transmission power to 5 dBm instead of 2 dBm which results in wasting transmission power and higher interference level.

With regard to power control, one possibility is to include a transmit power correction (TPC) command in the uplink scheduling grant sent in the downlink L1/L2 control channel to correct for estimation and accuracy errors. The TPCs received by a UE could be accumulated (to correct measurement and PA errors) or not accumulated (to compensate the time/frequency selectivity of the channel). The later could be sent with the uplink grant and the former could be sent on when needed.

The TPC command could be in the form of a dB power correction (P_{TPC}) given by:

P_{TPC}=f(expected & actual received UL RS power, link errors)

with a range of from −4 dB to 2 dB in 2 dB steps which can be represented with a 2 bit field. An MCS adjustment determined using UL link error and RS received power or SINR information can reduce the size or need for an eNode-B transmit power correction sent on a UL scheduling grant.

Therefore, the UE transmit power per resource block (P_{TXul}) would be computed as

P_{TXul}=P_{L}(dBm)+P_{TPC}(dB)

A UEs maximum total transmit power limit (P_{MAX}) nominal for its class can be de-rated by an amount (β) dependent on the channel bandwidth and channel location in the carrier to better reflect its OOB emission impact and to minimize the required de-rating instead of always using a worst case de-rating factor. Therefore, a UE's transmit power per resource block after limiting is given by

P_{TX}=min{P_{TXul},β(channel BW, channel location in carrier)*P_{MAX}/N_{RB}}

In the future pathloss may be one of the measurements periodically reported by each UE on a ˜50 ms basis. The pathloss measurements besides being used to synchronize the power control state at the UE and eNodeB would also be used for eNB interference coordination and handover functions. Also it is likely CQI will be periodically transmitted by each UE such that a pathloss report could once every 50 ms displace a CQI report by using the CQI uplink resource. (It is also possible the pathloss report could be “piggy backed” (multiplexed with data before DFT precoder) on uplink shared channel transmissions.) The SINR determined from reference signal symbols sent with CQI and pathloss reports as well as the estimated symbol SINR of the reports themselves can serve as the basis for determining a transmit power correction (TPC) on a 50 ms or less (every 2 ms e.g.) basis.

In conclusion, pathloss based uplink (fractional) power control is disclosed in the present invention. The errors due to estimation and accuracy can be compensated for by adjusting MCS selection during scheduling and by sending a transmit power correction (TPC) via the scheduling grant message. MCS and power adjustments can be based on estimated received RS power or SINR and link error information. TPC is to account for biases due to accuracy/estimation errors and not to track fast fading.

While the present invention has been particularly shown and described with reference to particular embodiments thereof, it will be understood by those skilled in the art that various changes may be made and equivalents substituted for elements thereof without departing from the scope of the invention as set forth in the claims below. Accordingly, the specification and figures are to be regarded in an illustrative rather then a restrictive sense, and all such changes and substitutions are intended to be included within the scope of the present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any variation thereof, are intended to cover a non-exclusive inclusion, such that a process, method, article, or apparatus that comprises a list of elements does not include only those elements but may include other elements not expressly listed or inherent to such process, method, article, or apparatus. The terms ‘including’ and/or ‘having’, as used herein, are defined as comprising. Furthermore, unless otherwise indicated herein, the use of relational terms, if any, such as first and second, top and bottom, and the like are used solely to distinguish one entity or action from another entity or action without necessarily requiring or implying any actual such relationship or order between such entities or actions. An element preceded by “ . . . a” does not, without more constraints, preclude the existence of additional identical elements in the process, method, article, or apparatus that the element.

What is claimed is:

1. A method for uplink power control by a Node B in a communication system, the method comprising the steps of:
measuring, by the Node B, at least one system performance metric;
sending, by the Node B, an indicator for the at least one system performance metric measurement;
receiving the indicator for the at least one system performance metric measurement;
determining an adaptive power control parameter based on the at least one system performance metric measured by the Node B and system performance metrics measured by at the least one other neighboring Node B; and
using the adaptive power control parameter to update an uplink transmit power level for at least one user equipment served by the Node B.

2. The method of claim 1, wherein the system performance metric comprises at least one of the group of, an interference level, a number of user equipment in serving cell, a fairness criterion, a cell edge user throughput, and a sector throughput.

3. The method of claim 1, wherein each indicator is quantized as one-bit.

4. The method of claim 1, wherein the sending step includes sending a first indicator of interference level and a second indicator of uplink performance.

5. The method of claim 1, wherein the sending step includes sending the indicator for the at least one system performance metric measurement from the Node B via a backhaul through an edge gateway, and the receiving step includes receiving the indicator forwarded by the edge gateway by the at least one other neighboring Node B, wherein the determining step is performed by the at least one other neighboring Node B.

6. The method of claim 1, wherein the measuring step includes measuring at least one system performance metric by a plurality of Node Bs, the sending step includes sending an indicator for the at least one system performance metric measurement by the plurality of Node Bs, the receiving step includes receiving the indicators by an edge gateway, wherein the edge gateway adapts the power control parameters for the Node Bs and forwards the updates to the Node Bs, such that the determining step is performed by the edge gateway.

7. The method of claim 1, wherein the measuring step includes measuring at least one system performance metric by a plurality of Node Bs, the sending step includes sending an indicator for the at least one system performance metric measurement by the plurality of Node Bs, the receiving step includes receiving the indicators by an edge gateway, wherein the edge gateway pre-processes the indicators for the Node Bs and forwards the pre-processed information to the Node Bs, such that the determining step is performed by both the edge gateway and the plurality of Node Bs.

8. The method of claim 7, wherein the pre-processing includes comparing the number of Node Bs sending a particular indicator value against a threshold, wherein if the number of Node Bs sending a particular indicator value is greater than the threshold, the edge gateway sends the particular indicator value to the Node Bs.

9. The method of claim 1, wherein the using step includes a Node B sending updated power control parameters to user equipment it serves.

10. The method of claim 1, wherein further comprising the steps of:
measuring a downlink path loss by a user equipment;
updating the uplink transmit power level;
reporting the downlink path loss to the serving Node B;
correcting errors using the reported downlink path loss; and
sending corrected power control commands to the user equipment.

11. The method of claim 10, wherein the correcting step includes at least one of the group of, providing accumulated correction to the user equipment for measurement and power errors, and providing non-accumulated compensation to the user equipment for channel dependent scheduling.

12. The method of claim 11, wherein one bit is sent to differentiate the accumulated correction and the non-accumulated compensation.

13. The method of claim 11, wherein the accumulated correction and the non-accumulated compensation is differentiated by sending at different timing or channels.

14. A Node B for providing uplink power control in a communication system, the Node B comprising:
a processor that measures at least one system performance metric and sends and receives an indicator for the at least one system performance metric measurement via a network backhaul between neighboring Node Bs, the processor configures an adaptive power control parameter based on the at least one system performance metric measured by the Node B and system performance metrics measured by at the least one other neighboring Node B, and uses the adaptive power control parameter to update an uplink transmit power level for at least one user equipment served by the Node B.

15. The Node B of claim 14, wherein the system performance metric comprises at least one of the group of, an interference level, a number of user equipment in serving cell, a fairness criterion, a cell edge user throughput, and a sector throughput.

16. The Node B of claim 14, wherein each indicator is quantized as one-bit.

17. The Node B of claim 14, wherein the Node B sends a first indicator of interference level and a second indicator of uplink performance.

18. The Node B of claim 14, wherein the indicator for the at least one system performance metric measurement is sent from the Node B via a backhaul through an edge gateway, and the Node B receives indicators forwarded by an edge gateway from at least one other neighboring Node B.

19. The Node B of claim 14, wherein the Node B receiving the adapted power control parameters from an edge gateway.

20. The Node B of claim 14, wherein the indicator received for the at least one system performance metric measurement is pre-processed in an edge gateway, which the Node B uses to configure the adaptive power control parameter.

21. The Node B of claim 20, wherein the pre-processed indicator is derived from comparing the number of Node Bs sending a particular indicator value against a threshold, wherein if the number of Node Bs sending a particular indicator value is greater than the threshold, the Node B receives the particular indicator value.

22. The Node B of claim 14, wherein the Node B sends updated power control parameters to user equipment it serves.

23. The Node B of claim 14, wherein the Node B receives a downlink path loss by a user equipment, updates the uplink transmit power level, corrects errors using the reported downlink path loss, and sends corrected power control commands to the user equipment.

24. The Node B of claim 23, wherein the Node B corrects measurements by at least one of the group of, providing accumulated correction to the user equipment for measurement and power errors, and providing non-accumulated compensation to the user equipment for channel dependent scheduling.

25. The Node B of claim 24, wherein the Node B sends one bit to differentiate the accumulated correction and the non-accumulated compensation.

26. The method of claim 24, wherein the Node B sends the accumulated correction and the non-accumulated compensation at different timing or channels.
